(19) United States
(12) Patent Application Publication
(10) Pub. No.: US 2008/0302718 A1
(43) Pub. Date: Dec. 11, 2008

(54) Removable retention screen for drinking vessel

(76) Inventor: Michael Hardy, Lawrenceville, GA (US)

Correspondence Address: INTELLECTUAL PROPERTY CENTER, LLC, 9233 WARD PARKWAY, SUITE 100, KANSAS CITY, MO, 64114, US

(21) Appl. No.: 11/505,074

(22) Filed: Aug. 16, 2006

Related U.S. Application Data
(63) Continuation-in-part of application No. 10/645,783, filed on Aug. 22, 2003, now abandoned.

(51) Int. Cl. B01D 35/02

(52) U.S. Cl. 210/469; 210/474; 210/477; 426/87

(57) ABSTRACT

A new use for a circular, solids retention screen for removable use with a variety of sizes of circular drinking vessels to allow for the separation of liquid from solids contained within the vessel. Typical embodiments for the vessel size can be a drinking glass to allow the user to drink without disruption from the contained ice, whether crushed or cubes. For this embodiment, the invention relies upon a retention screen comprising a continuous, circular, flexible, elastomeric ring. The ring is constructed of an annular base portion with a continuous tapered portion extending radially outwardly from the base portion. Finally, a central, generally flat, liquid passing screen portion is secured from the base portion.

### RELATED APPLICATION

The present invention is a Continuation-in-Part of U.S. Ser. No. 10/645,783, filed Aug. 22, 2003, by the inventor hereof, filed under the title, “Removable Retention Screen for Vessel”, where the contents thereof are incorporated by reference.

### FIELD OF THE INVENTION

This invention is directed to the field of a solids shielding screen for removable use with a vessel, preferably for use as a drinking vessel, more particularly to the new use of a removable solids shielding screen to allow, for example, drinking without interference with ice, i.e. crushed or cubes.

### BACKGROUND OF THE INVENTION

The present invention relates to the new use of a solids shielding screen in combination with a vessel for receiving fluid/solids, where the screen may be removable inserted into said vessel to allow the easy separation of the fluid from the solids, and to shield the user while drinking. The prime example of such a removable screen is a cold drinking vessel containing ice where the drinker desires to drink without concern for the ice cubes. The invention, for vessels both large and small, accomplishes the desired goals with an effective removable screen member.

While the invention has particular utility for a drinking vessel, as noted above, it has broad application to different sizes of vessels for a variety of purposes Notwithstanding, the further description will be directed to the preferred use for a drinking vessel for convenience in understanding the advantages of the invention. Very few people have not experienced the problem of drinking a cold drink when the ice therein suddenly shifts causing a spill on the drinker's face or clothing, or of being bumped while attempting to drink. The prior art contains a number of devices that offer some solutions, albeit complex in some cases, to meeting the drinker's needs. Certain of such devices are described in the following U.S. patents:

a.) U.S. Pat. No. 6,247,212, to Grana Igesias, teaches a device for retaining solids in a drinking glass that comprises a clamp connected to a grid via a hinge. The clamp and grid are initially positioned flat but upon rotation of the hinge, the clamp and grid are positioned perpendicular to each other for use. The flat configuration makes manufacturing and shipping easier and less expensive. Upon rotation of the hinge; the clamp and grid are locked into the perpendicular position via interlocking elements on the clamp and grid. The grid prevents solids in the glass from traveling with the liquid as the glass is being tilted, thus eliminating spills and discomfort to the user.

b.) U.S. Pat. No. 5,727,712, to Costello, is directed to a device for retaining ice in a drinking glass while permitting the beverage therein to be enjoyed. The device comprises a shield shaped to conform generally to at least a portion of an interior cross-section of the glass at a chosen distance below the lip thereof. The device further includes a stem attached at one end to the shield and at the other end to a clip. The stem is of a length so that the shield will be positioned at the chosen distance below the lip of the glass when the clip is engaged on the lip thereof. In the preferred embodiments, the shield is substantially the same size as the interior cross-section of the glass at the chosen distance and includes a plurality of holes sized to retain the ice in the glass while permitting the beverage to flow freely therethrough. In the most preferred embodiments, the clip is pivotally attached to the opposite end of the stem and spring biased to firmly engage the lip of the drinking glass.

c.) U.S. Pat. No. 5,059,319, to Welsh, covers a device used to strain paint and other liquid products. The device includes a piece of mesh material fixed at its perimeter in a ring. The material and cross-sectional shape of the ring is designed to permit compression of the shape, allowing the ring to conform to, and bias against, the lid well of a container, such as that of a paint can, by press fit. Compression of the cross-sectional shape of the ring may be facilitated by the placement of an elastomeric spline in a channel of the ring. That is, the device engages the lid well of the paint can, where the lid well is an annular channel about the top of the paint can.

d.) U.S. Pat. No. 4,842,157, to Stone-Parker et al., discloses a drinking container having a retainer device to retain relatively large objects such as ice cubes therebeneath. The retainer device has a central portion which may contain printed indicia and a plurality of resilient arms extending radially outwardly to resiliently engage the container. A porous pouch adapted to receive an additive for release of an ingredient into the liquid may be mounted to the bottom of the central position.

d.) U.S. Pat. No. 4,020,532, to Lichter, relates to a one piece molded plastic device for a drinking glass that includes a body presenting a face that can receive indicia and an integral clip having convergent sidewalls depending from an integral bight portion. One of the sidewalls is connected to the body and the other sidewall is longer than the first sidewall and extends below the body. The clip is positionable over marginal portions along the free edge of generally thin objects. The device has been improved by adding a pair of laterally spaced ribs. The ribs are formed integrally and longitudinally of the second sidewall and protrude toward the body for gripping the marginal portion of the objects therebetween. A deformable hinge may also be provided integrally with the body and clip where the first sidewall is connected to the body for selectively adjusting the relative orientation of the body and the clip as desired.

e.) U.S. Pat. No. 2,753,049, to Gaines et al., teaches a strainer-protector for a drinking vessel. The device includes a circular retainer ring for mounting to the vessel rim, and features an annular, internally directed member, two embodiments, to help control ice cubes when desiring to drink from the vessel.

f) U.S. Pat. No. D-345,889, to Herricks, U.S. Pat. No. D-315,478, to Liggens, and U.S. Pat. No. D-353,298, to Hartpence, Jr. et al., illustrate different designs for devices to control or restrict ice cubes in a drinking glass, where the two former Design patents show restrainer members within the glass, and the third shows an overriding screen member for the glass.

Despite the seemingly functionality of the prior art devices, of which the foregoing are exemplary, these prior art devices suffer many disadvantages. The majority of them are generally of a single fixed size, that precludes adaptability of a single device to a plurality of different sizes and shapes of drinking containers. The adaptability of the prior art devices is also minimized or negated by their mounting structures which are generally cumbersome and often require interaction and hence also interference with the top or bottom of the container. Such interaction also presents the danger of cracking or breaking the container. Moreover, all of these devices except that shown in the Gaines et al. patent ('049), are similiar or analogous to a strainer in that they substantially and/or uniformly cover the area across the container, leaving relatively small openings for the flow of liquid therethrough. This arrangement is anesthetically inferior in that it creates a mental barrier between the user and the liquid contents and prevents the free flow of and access, e.g., to the liquid to stir the same or to add new solid ingredients or the like. These strainer like devices also suffer from the disadvantage that they are of relatively complex shapes, thereby making them expensive to manufacture and difficult to clean for possible reuse. Finally, the devices are generally visible to others which can be unsightly and not particularly desirable.

The present invention, unlike the prior art, relates to a removable shielding screen for a vessel that is fully contained within and along the inner wall of the vessel, and is effective in providing the desired effect of allowing the user to drink or dispense liquid from the vessel without concern for any solids, such as ice, passing through the shielding screen interfering with the user while drinking or sliding onto the user. The manner by which this invention achieves the goals hereof will become apparent in the description which follows, especially when read in conjunction with the accompanying drawings.

### SUMMARY OF THE INVENTION

The invention, as more fully detailed hereafter, is directed to a removable shielding screen for a vessel, such as a drinking vessel. Typically, the vessel is characterized by a circular cross section with a base and upstanding side walls, and an open top, having a circular rim, for accessing the vessel. The shielding screen is characterized by an annular, elastomeric ring, tapered from a base portion outwardly to a thin edge capable of deforming in intimate contact with the upstanding inner side-wall and providing a liquid tight seal thereagainst. Within the elastomeric ring is a liquid passing screen or mesh having sufficient strength to retain any solids, such as ice cubes or food products processed within the vessel, when the vessel is tilted for dispensing the liquid. By this arrangement, the shielding screen is temporarily retained within the vessel until removed for cleaning and/or replenishing the liquid, i.e. drink with new ice. To add a decorative note to the retention screen of this invention, the screen or mesh may be provided with indicia, a design or logo that is readily visible to the user of the vessel.

Accordingly, a feature of this invention is the provision of a flexible, product shielding screen for positioning within a vessel against the inner side-wall thereof to retain any solids therewithin when the vessel is tilted to dispense the liquid, such as by drinking or straining the liquid from the solids.

Another feature hereof lies in the use of a fully contained, elastomeric shielding screen placed within a vessel in a removable but sealing engagement with the vessel wall.

A further feature of the invention is the provision of a vessel shielding screen or mesh that can be readily printed with informative indicia or designs to indentify locales or sources, as may be desired by the user thereof.

These and other features of this invention will become clearer in the description which follows.

### BRIEF DESCRIPTION OF DRAWINGS

FIG. 1 is a perspective view of the removable screen member according to this invention, where the screen member is shown disposed within a drinking vessel to restrict the release of the contained ice cubes upon tilting the vessel for drinking.

FIG. 2 is a top view of the vessel and screen member illustrated in FIG. 1.

FIG. 3 is a diametric sectional view of the screen member of FIG. 2.

### DETAILED DESCRIPTION OF PREFERRED EMBODIMENT

The present invention relates to a solids shielding screen or mesh member for removable placement within a vessel to retain solids, such as ice, while allowing the free and uninterrupted dispensing of liquid from the vessel. The invention will now be described with regard to the several accompanying drawings, where like reference numerals represent like components or features throughout the several views.

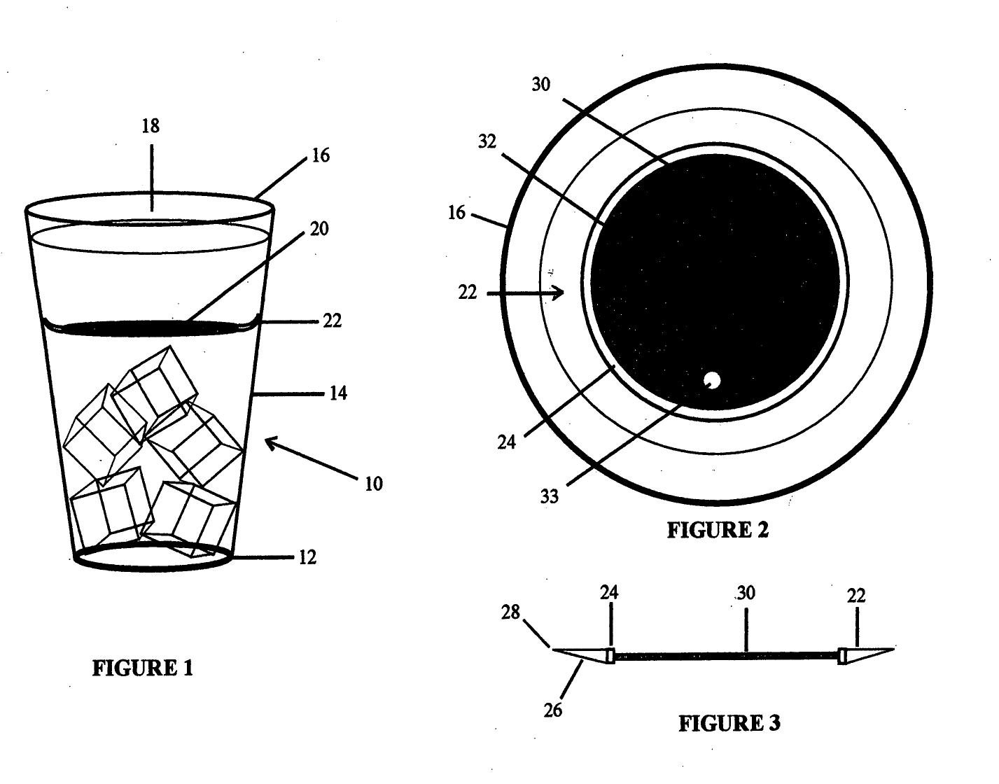

Turning first to FIG. 1, illustrating a perspective view of drinking glass or vessel 10, a preferred use for the invention, the vessel is characterized by a circular base 12, and an upstanding and continuous side wall 14 terminating in a circular rim 16 to define an opening 18 for accessing the vessel 10.

Disposed within the vessel 10 is positioned a removable shielding screen 20, see also FIGS. 2 and 3. The removable shielding screen 20, as best illustrated in FIGS. 2 and 3, comprises a rubber like or elastomeric ring 22 sized for sliding and intimate engagement with the upstanding inner side-wall 14 as shown in FIG. 1. The elastomeric ring 22 includes a broad annular base portion 24 and an outwardly extending tapered portion 26 that terminates in a thin, flexible edge 28 for deforming against the vessel's inner side wall 14, thus providing a temporarily fixed liquid seal. Note in particular in FIG. 1 where the flexible edge 28 is shown pressed upward in intimate contact with the inner wall of the vessel 10. Disposed within the broad base portion 24, and fixed therewithin, is a liquid passing screen or mesh portion 30, to prevent the premature removal of solids, such as ice cubes (see FIG. 1). With the solids shielding screen removably secured within the vessel 10, one can easily drink the refreshing liquid without having to be concerned with the ice or the sudden shifting of the ice cubes and spilling the drink on the user. When the drink is finished, and refilling is desired, one merely pours more liquid into the vessel. When more ice is desired one merly removes the shielding screen and replenishing of the contents is made with the shielding screen returned to the position overriding the ice cubes, see FIG. 1.

FIG. 2 illustrates a further advantage to the shielding screen 20 of this invention. The screen or mesh portion 30 may be provided with selected indicia or designs to allow the server to advertise or entertain the user as he/she drinks. Specifically, the screen or mesh portion may be printed with a ‘name’ or logo 32. Further, the screen or mesh portion 30 may be provided with a straw opening 33 should one desire to drink through a straw without interference with the ice.

It is recognized that changes, variations or modifications may be made to the invention, specifically the retention screen, without departing from the spirit and scope of the invention. For example, the retention screen may be provided with a tab or extension member for the easy withdrawal of the retention screen from the vessel. Accordingly, no limitation is intended to be imposed thereon except as set forth in the appended claims.

I claim:

1. A new use for a circular, solids shielding screen for removable use with a complimentry sized, liquid drinking circular vessel for retaining solids within said vessel while shielding the user from the solids therein and allowing liquid to be dispensed therefrom, said circular vessel defined by an inner tapered wall, a closed base and an upper open rim, said retention screen comprising:
a continuous circular, flexible, elastomeric ring, said ring constructed of an annular base portion with a continuous, uniformly tapered portion extending radially outwardly from said base portion, and a central, liquid passing screen portion secured from said base portion, wherein said ring is sized to be recessed into said vessel in intimate contact with said tapered wall.

2. The new use for a circular, solids shielding screen according to claim 1, wherein said tapered portion terminates at a thin edge to allow for flexing thereof into intimate contact against said inner tapered wall within said vessel.

3. The new use for a circular, solids shielding screen according to claim 1, wherein said liquid passing screen portion contains selected indicia.

4. The new use for a circular, solids shielding screen in combination with a generally circular, liquid drinking vessel featuring a base and a continuous upstanding, internal tapered wall terminating in a continuous rim defining an opening for accessing said vessel, a circular retention screen comprising a continuous circular, flexible, elastomeric ring, said ring constructed of an annular base portion with a continuous, uniformly tapered portion extending radially outwardly from said base portion for contacting said internal tapered, upstanding wall, and a central, liquid passing screen portion secured from said base portion.

5. The new use for the combination according to claim 4, wherein said tapered portion terminates at a thin edge to allow for flexing thereof into intimate contact with said upstanding wall.

6. The new use for the combination according to claim 4, wherein said liquid passing screen portion contains selected indicia.
